(19) United States
(12) Patent Application Publication
(10) Pub. No.: US 2026/0092522 A1
(43) Pub. Date: Apr. 2, 2026

(54) DUAL-PERSON DUAL-MACHINE MEASUREMENT METHOD FOR MINING AND TRANSPORTATION EQUIPMENT

(71) Applicant: TAIYUAN UNIVERSITY OF TECHNOLOGY, Taiyuan (CN)

(72) Inventors: Xuewen WANG, Taiyuan (CN); Jiacheng XIE, Taiyuan (CN); Jiayi ZHAO, Taiyuan (CN); Rui DU, Taiyuan (CN); Jiapeng ZHANG, Taiyuan (CN); Yiwen WANG, Taiyuan (CN); He CHEN, Taiyuan (CN); Hui LI, Taiyuan (CN); Peilin ZHANG, Taiyuan (CN); Yu YUAN, Taiyuan (CN)

(21) Appl. No.: 19/087,942

(22) Filed: Mar. 24, 2025

(30) Foreign Application Priority Data
Sep. 30, 2024 (CN) 202411377315.8

(51) Int. Cl. E21C 35/00; G06F 3/01

(52) U.S. Cl. CPC E21C 35/302; G06F 3/011

(57) ABSTRACT

A dual-person dual-machine measurement method for mining and transportation equipment is provided, including an intelligent measurement module, a measurement user module, and a measurement task module. The intelligent measurement module includes two inspectors conducting inspections in opposite directions and Augmented Reality (AR) glasses carried by the inspectors, and is configured to collect data based on Hololens equipment. The measurement user module is built into edge computers carried by the inspectors and includes a multi-user collaborative platform, where the multi-user collaborative platform measures working-face mining-transportation pose data under AR assistance and performs data processing operations, and the multi-user collaborative platform enables real-time collaboration of measurement perspectives and data among multiple users. The measurement task module is responsible for clarifying measurement tasks for the multi-user collaborative platform and for solving data feedback from the measurement tasks, and simultaneously feeds back solving results to an inspection AR end in the form of tasks.

### CROSS REFERENCE TO RELATED APPLICATION

This patent application claims the benefit and priority of Chinese Patent Application No. 2024113773158, filed with the China National Intellectual Property Administration on Sep. 30, 2024, the disclosure of which is incorporated by reference herein in its entirety as part of the present application.

### TECHNICAL FIELD

The present disclosure relates to the technical field of intelligent inspection for fully-mechanized mining faces, and in particular, to a dual-person dual-machine measurement method for mining and transportation equipment, driven by a combination of manual matching and automatic tracking.

### BACKGROUND

Intelligent coal mines are the core technical support for the high-quality development of the coal industry and is an essential path for the transformation and upgrading of the coal mining industry. Currently, coal mining is still in a partially unmanned development stage, where humans play an important role in the fully-mechanized mining system. There is a high demand in the coal industry for the development of intelligent fully-mechanized mining faces, especially in the area of inspection for fully-mechanized mining. It is difficult to guarantee the measurement effectiveness of existing mechanical sensors and simultaneous localization and mapping (SLAM) point cloud technology in narrow working faces, which can lead to challenges in the positioning of fully-mechanized mining equipment and difficulties in measuring its pose. Due to these issues, not only is the efficiency of inspection hard to ensure, but subsequent dynamic inspection work is also difficult to advance and develop. Therefore, the development of AR measurement plays a crucial role in promoting future intelligent inspections.

The invention patent with publication number CN114186403A discloses a real-time precise virtual deduction method for the pose of a floating connection mechanism of comprehensive support and transportation equipment. First, based on conformal geometry, the spatial combined motion of the floating connection mechanism is transformed into the transformation relationship between points, lines, and planes, obtaining the motion law of the floating connection mechanism. Then, by changing the rotation of each middle trough of the scraper conveyor, the direction vector is altered, thereby updating the motion values of each structure of the floating connection mechanism, ultimately achieving adaptive advancement of the hydraulic support group and the scraper conveyor. The scraper conveyor is discretely decomposed into several middle troughs, driven based on the rotation of each middle trough, establishing a posture reconstruction of the scraper conveyor based on coordinate information. This invention eliminates the influence of the sequence of motions with different degrees of freedom of the floating connection mechanism, allowing for direct solving of the motion of each structure. After virtual application, the motion of the floating connection mechanism can be quickly reconstructed, thus quickly deducing the pose relationship between the hydraulic supports and the scraper conveyor. However, complete virtual deduction fails to cope with the real complex conditions underground. The present disclosure proposes a measurement method driven by a combination of manual matching and automatic tracking, eliminating the need for traditional physical sensors, enhancing human subjectivity, and more accurately presenting the real conditions underground.

The invention patent with publication number CN113051756A discloses a virtual-real-fused memory cutting test system and method for a coal mining machine. The system includes a virtual testing scene, a virtual-real interaction system, and a test platform. The coal mining machine is installed on the test platform, and workers operate the coal mining machine to perform demonstration cutting operations. The sensors installed on the coal mining machine transmit signals in real time to the virtual testing scene, driving the virtual coal mining machine to operate in the virtual coal seam and displaying various data for workers' reference. The autonomous prediction data for memory cutting comes from the real coal mining machine controller, driving the virtual coal mining machine to operate and presenting the memory cutting effect on the test platform, allowing for the export of predicted data for comparative analysis with manual operation data to verify the effectiveness of memory cutting. This solution addresses many issues, including the current testing of memory cutting being limited to actual underground environments, the enormous manpower and resources required for the testing process, the numerous risk factors and high danger levels in actual underground environments, and the difficulties and low feasibility of testing. This patent uses virtual-real fusion technology to construct different fully-mechanized mining scenarios, but there is still a gap compared to real fully-mechanized mining scenarios. The present disclosure, based on virtual-real fusion, fully leverages human initiative, allowing experienced inspection personnel to flexibly calibrate measurements on the working face to compensate for the shortcomings present in the simulation of virtual scenes.

The invention patent with publication number CN117540518A discloses an underground pipeline inspection apparatus and method based on three-dimensional real scene virtual-real fusion, relating to the technical field of three-dimensional real scene virtual-real fusion inspection. The apparatus includes a three-dimensional real scene acquisition device, a data processing unit, a virtual model generation unit, and a fusion display unit. The three-dimensional real scene acquisition device is configured to collect real scene data of underground pipelines, where the real scene data includes environmental three-dimensional parameters, location data of the underground pipelines, and three-dimensional contour data of the underground pipelines. The three-dimensional real scene acquisition device transmits the real scene data to the data processing unit. This invention achieves comprehensive and precise acquisition and modeling of the actual scene of underground pipelines through the three-dimensional real scene acquisition device and data processing unit. The virtual model generation unit automatically identifies the types, locations, and orientation information of the underground pipelines and generates a virtual model corresponding to the actual scene. The fusion display unit integrates and displays the three-dimensional real scene with the virtual model, achieving real-time and precise underground pipeline inspections. This patent uses an electric cart as an inspection executor, which is equivalent to a single-user inspection. The present disclosure adopts a dual-person multi-user inspection strategy and designs a multi-user collaborative platform, providing assistance for future promotion to multi-user or multi-cart scenarios.

The invention patent with publication number CN115456361A discloses a method, system, and storage medium for detecting and managing abnormal states of inspection personnel, belonging to the field of inspection detection. The method includes acquiring the location of inspection personnel in real time based on a smart terminal of the inspection personnel; determining whether the location of the inspection personnel has changed within a preset time period; if the location of the inspection personnel has not changed, checking whether the smart terminal is online; if the smart terminal is online, acquiring a preset endpoint location; determining whether a distance between the acquired location and the endpoint location is less than a preset distance threshold; if the distance is not less than the threshold, determining that the inspection personnel are in an abnormal state and sending a prompt message to the smart terminal; generating and displaying a work trajectory according to a working time node based on the location that is acquired in real time before the abnormal state of the inspection personnel occurs. This patent determines whether the inspection status is abnormal based on the terminal battery level and memory usage of the smart terminal, while the present disclosure proposes a pose calculation method for inspection personnel to assess the work path of the inspection personnel, which is more intuitive compared to the logic of the aforementioned patent.

The invention patent with publication number CN118017461A discloses a method for topology identification and line loss analysis of distribution transformer areas based on cloud-edge collaboration. The method includes the following steps: the cloud server establishes an initial topology identification and line loss analysis model and distributes initial model parameters to each intelligent fusion terminal participating in joint modeling; the intelligent fusion terminal completes training of a lightweight computational model locally, and after training, uploads model parameters to the cloud server; the cloud server aggregates and optimizes the model parameters from each intelligent fusion terminal; the cloud server updates the global model based on the aggregated results and returns updated model parameters to the intelligent fusion terminals participating in modeling; the intelligent fusion terminals iteratively update and optimize the local models until the performance reaches the target. The method of this invention integrates distributed collaborative computing with cloud-edge collaborative computing, making it suitable for application scenarios of efficient topology identification and real-time line loss analysis in large-scale low-voltage distribution networks, supporting the construction of new power systems. The present disclosure still adopts a cloud-edge collaborative strategy, with the inspection AR end as the measurement end, measuring and integrating initial parameters; the VR end serves as the subsequent calculation end; after the inspection AR end completes basic data measurement and preprocessing locally, the pose of the mining and transportation equipment and the cooperative pose between the mining and transportation equipment and support equipment are calculated at the cloud, which are finally fed back to frontline inspection personnel. The main difference between the present disclosure and the aforementioned patent is the emphasis on a human-centered concept, with inspection personnel acting as the on-site decision-making terminal.

The pose detection mentioned in the above patents occurs during the virtual simulation phase. To apply this to real production, it is necessary to further promote the virtual simulation to actual working faces.

### SUMMARY

An objective of the present disclosure is to provide a dual-person dual-machine measurement method for mining and transportation equipment, which integrates manual matching and automatic tracking technology, employing a multi-user synchronous inspection strategy to achieve collaborative inspections between two Hololens devices.

To achieve the above objective, the present disclosure adopts the following technical solution:

A dual-person dual-machine measurement method for mining and transportation equipment, including an intelligent measurement module, a measurement user module, and a measurement task module.

The intelligent measurement module includes two inspectors conducting inspections in opposite directions and Augmented Reality (AR) glasses carried by the inspectors, and is configured to collect working-face mining-transportation pose data based on Hololens equipment by using manual matching and automatic tracking methods.

The measurement user module is built into edge computers carried by the inspectors and includes a multi-user collaborative platform, where the multi-user collaborative platform measures the working-face mining-transportation pose data under AR assistance and performs data processing operations, and the multi-user collaborative platform enables real-time collaboration of measurement perspectives and data among multiple users.

The measurement task module is responsible for clarifying measurement tasks for the multi-user collaborative platform and for solving data feedback from the measurement tasks, where driven by tasks, a virtual solving platform is built for an actual working state of mining and transportation equipment; pose information of a scraper conveyor and a coal mining machine is solved in real time based on measurement data fed back by users, and is used for collaborative solving of pose information of a hydraulic support group in the multi-user collaborative platform, thereby integrating the pose information of the mining and transportation equipment with the pose information of the support equipment, and solving results are simultaneously fed back to an inspection AR end in the form of tasks.

As a preferred embodiment, the multi-user collaborative platform, based on the working-face mining-transportation pose data under AR assistance, integrates a multi-Hololens platform collaboration module and a network interaction module, uses a Vuforia tool to perform real scene scanning of fully-mechanized mining equipment in a working face, constructs a virtual model at a virtual end, and integrates the virtual model into the inspection AR end, where AR devices identify and track the fully-mechanized mining equipment operating in a real working face, measuring pose information of corresponding parts in real time.

As a preferred embodiment, the method includes establishing a three-level coordinate system in a fully-mechanized mining face.

A first-level coordinate system is a coal seam coordinate system, with an initial mining position of a coal seam as an origin of the coal seam coordinate system, a layout direction of the working face as an X-axis, a horizontal advancement direction of the working face as a Y-axis, and a vertical direction as a Z-axis, used for locating all coordinate systems in the working face.

A second-level coordinate system is a working face coordinate system formed by an overall configuration of three fully-mechanized mining machines, with a geometric center of a head cross-section of the scraper conveyor taken in a center-symmetric plane of a first head support in a head direction of the scraper conveyor as an origin, and coordinate axes being always parallel to the coal seam coordinate system.

A third-level coordinate system includes local coordinate systems for each piece of equipment and an AR coordinate system, where the coal mining machine uses a geometric center of a body of the coal mining machine as a coordinate system origin, with a direction parallel to the body as an X-axis, a direction perpendicular to a front and back plane of the body as a Y-axis, and a direction perpendicular to an upper plane of the body as a Z-axis; the scraper conveyor is first divided into a plurality of units based on the number of middle troughs, and each middle trough unit uses a geometric center of an upper plane of the trough as a coordinate system origin, a direction parallel to a bottom plate and pointing towards the rear as an X-axis, a direction parallel to the bottom plate and pointing towards a coal wall as a Y-axis, and a direction perpendicular to a floor and pointing upwards as a Z-axis; the AR coordinate system is jointly formed by the two inspectors, with a geometric center of a Hololens device as a coordinate system origin, an inspection route along the layout direction of the working face as an X-axis, the horizontal advancement direction of the working face as a Y-axis, and the vertical direction as a Z-axis.

As a preferred embodiment, a data processing flow of the multi-user collaborative platform includes anchor calculation, involving scene anchors and spatial anchors.

The scene anchors are pre-calibrated during a virtual development process, based on static positions of the three fully-mechanized mining machines, and a scene anchor coordinate system formed by the scene anchors belongs to the second-level coordinate system of an entire coordinate system set.

The spatial anchors are calibrated based on dynamic conditions of the three fully-mechanized mining machines, flexibly calibrated by the inspectors during an inspection process according to actual operating conditions of the working face, and after an inspection shift, saved as inspection data for the inspection shift, where the inspection data gradually iterates as the number of inspection shifts increases; a spatial anchor coordinate system formed by the spatial anchors belongs to the third-level coordinate system of the entire coordinate system set.

As a preferred embodiment, the data processing flow of the multi-user collaborative platform includes lightweight calculation to filter complex data; filtered complex data is uploaded to a virtual reality (VR) end via a local area network, and complex calculations are performed by the VR end, while simpler calculations are quickly performed by the inspection AR end.

As a preferred embodiment, for pose calculation at the inspection AR end, a robotic arm model is used to determine pose conditions of the fully-mechanized mining equipment and the inspectors by analyzing pose matrix change matrices of different objects at different times; for pose calculation of the fully-mechanized mining equipment, a base is first determined, and coordinate transformation matrices of each actuator point in joints of the fully-mechanized mining equipment are expressed in relation to the base, thus reflecting the pose conditions of the entire fully-mechanized mining equipment; for pose calculation of the inspectors, by treating the inspectors as point masses in space and using the scene anchors as a reference, positions of the inspectors in space are determined, coordinates of the inspectors are expressed in terms of scene anchor coordinates, and then a corresponding pose matrix is converted into a spatial position matrix based on the first-level coordinate system, thus reflecting inspection paths of the inspectors through feedback of inspector poses.

As a preferred embodiment, in the measurement task module, a data solving method is as follows: first, a preliminary development of the AR glasses worn by the inspectors is conducted, including three steps: building a Hololens+Unity3D platform, matching three-dimensional model feature blocks, and writing solution scripts in C#; ultimately, an AR taskbar displays pitch, yaw, and roll angles, as well as distance data of the scraper conveyor and the coal mining machine; after pose data of the mining and transportation equipment is obtained, the pose data is uploaded via the local area network, and collaborative solving for the mining and transportation equipment and the hydraulic support group is conducted in the cloud.

As a preferred embodiment, a method for collaborative solving of a pose relationship between the mining and transportation equipment and the hydraulic support group is as follows: for the scraper conveyor, the scraper conveyor is first divided into a plurality of units corresponding to hydraulic supports based on the number of floating connection mechanisms; poses of individual floating connection mechanisms and poses between adjacent floating connection mechanisms are analyzed to form an overall advancement spatial pose situation of the scraper conveyor; through a matching relationship between hydraulic cylinders of the floating connection mechanisms and bases of the hydraulic supports, a pose analysis task between the scraper conveyor and the hydraulic support group is completed; for the coal mining machine, an overall pose of the coal mining machine is first analyzed to form an overall operational spatial pose situation of the coal mining machine, and then, through a matching relationship between a cutting tool and a face guard of the hydraulic support, a pose analysis task between the coal mining machine and the hydraulic support group is completed.

As a preferred embodiment, a bidirectional matching verification method is used to achieve interaction between the mining and transportation equipment and the hydraulic support group; bidirectional matching verification is divided into two parts: a test set and a validation set; the test set is used for determining interaction results based on preset limit parameters by judging distance and angle parameters; the validation set is used for conducting virtual simulations in virtual space, and with a relationship between the support equipment and the mining and transportation equipment as a basis for judgment, verifying whether an operational relationship between the support equipment and the mining and transportation equipment is normal based on whether there is interference in virtual space models.

As a preferred embodiment, for the coal mining machine that operates more stably, a cloud-edge collaborative strategy is employed; by utilizing efficient feature recognition and tracking capabilities of the Vuforia tool, feature matching is performed on a three-dimensional feature block model and the coal mining machine based on a built-in nearest neighbor search algorithm, a random sample consensus (RANSAC) algorithm, and a RANSAC algorithm script; accuracy of matching results is verified at the inspection AR end, and ultimately, through the multi-user collaborative platform, complex data is uploaded to the cloud for precise calculations and cloud rendering, allowing the feature blocks to move together with the coal mining machine.

The present disclosure primarily focuses on the intelligent inspection of mining and transportation equipment in fully-mechanized mining equipment, specifically the scraper conveyor and coal mining machine, and proposes a “dual-person dual-machine” inspection approach that integrates manual matching and automatic tracking technology. By leveraging AR technology, it enables automatic tracking of operations in underground fully-mechanized mining faces. On this basis, a manual matching strategy is introduced to fully utilize the accuracy and detail of manual measurements. Additionally, manual measurements have irreplaceable advantages over traditional contact sensor measurements for scanning and measuring data in flooded underground areas, allowing for quick and accurate conversion of contact information into spatial information. Furthermore, to adapt to the rapid updates of pose information during the operation of the mining and transportation equipment, reduce inspection pressure, and improve inspection efficiency, a multi-user synchronous inspection strategy is proposed, a dual-Hololens-device inspection method for two users is designed, and a multi-user collaborative interaction platform is used for data transmission and rapid solving, thereby effectively achieving immersive collaborative inspections between the two Hololens devices.

The present disclosure integrates the multi-user collaborative interaction technology, virtual-real interaction technology, and data fusion technology from digital twin technology, and achieves the following technical effects:

(1) The present disclosure promotes AR inspections to multi-user scenarios, uses a dual-person multi-user inspection strategy, and designs a multi-user collaborative platform, providing a new concept for future promotion to multi-user or multi-carts inspections.

(2) The present disclosure introduces manual matching based on automatic tracking, fully leveraging human initiative: experienced inspectors use portable edge computers to convert

AR measurement data into pose data in real time, which not only aligns with the intuitive cognitive process of the human eye but also effectively filters information, quickly presenting valid information and enhancing the intelligence level of fully-mechanized mining operations.

(3) The present disclosure achieves immersive inspections of the working face through AR glasses, ensuring the safety of operators while improving the efficiency and accuracy of inspection operations. At the same time, it avoids difficulties in positioning and measuring poses of fully-mechanized mining equipment due to the unreliable measurement effects of existing mechanical sensors and SLAM point cloud technology in narrow working faces.

(4) The multi-user collaborative platform facilitates real-time data exchange between the working face and the centralized control command center, allowing command personnel to issue instructions and assign tasks to on-site inspectors, achieving comprehensive and full-process data interaction. Additionally, the two inspectors can communicate and discuss through the multi-user collaborative platform to promptly address any anomalies that arise in the working face.

(5) The present disclosure proposes an inspector pose calculation method based on a robotic arm model, treating the working face as the base of the robotic arm and the inspectors as the actuators of the robotic arm, directly determining operational paths of the inspectors through matrix pose transformations. This approach allows for more flexible human movement without the need for complex mechanical transmissions, making matrix representation more convenient and more accurately reflecting the inspection paths of the inspectors.

(6) The present disclosure adopts a cloud-edge collaborative strategy, with the inspection AR end as the measurement end, measuring and integrating initial parameters; the VR end serves as the subsequent calculation end; after the inspection AR end completes basic data measurement and preprocessing locally, the pose of the mining and transportation equipment and the cooperative pose between the mining and transportation equipment and the support equipment are calculated at the cloud, which are finally fed back to frontline inspection personnel. The present disclosure emphasizes a human-centered concept, with inspection personnel acting as the on-site decision-making terminal.

In summary, the rapid and efficient dual-Hololens measurement method for mining and transportation equipment, driven by a combination of manual matching and automatic tracking, proposed in the present disclosure is innovative and effective.

### BRIEF DESCRIPTION OF THE DRAWINGS

FIG. 1 is an overall framework diagram of a process implemented by the present disclosure;

FIG. 2 is a specific flowchart of a measurement user module;

FIG. 3 is a specific flowchart of a measurement task module;

FIG. 4 is a flowchart of data processing of a multi-user collaborative platform;

FIG. 5 is a flowchart of interaction between mining and transportation equipment and support equipment; and

FIG. 6 is a flowchart of automatic tracking.

### DETAILED DESCRIPTION OF THE EMBODIMENTS

The present disclosure provides a dual-person dual-machine measurement method for mining and transportation equipment, relating to driven by a rapid and efficient dual-Hololens measurement method for mining and transportation equipment, driven by a combination of manual matching and automatic tracking. The overall concept is to perform non-contact measurements of the mining and transportation equipment at the working face using Hololens devices driven by the combination of manual matching and automatic tracking, and then solve data through an edge computer and provide real-time feedback. First, for the mining and transportation equipment, an innovative intelligent measurement method that integrates manual matching and automatic tracking is proposed, leveraging human initiative. Using AR devices and edge computers, real-time operational data of the working face is corrected and adjusted according to actual working conditions. Secondly, based on intelligent measurement, a measurement user module and a measurement task module are designed: the measurement user module is used for task collaboration among multiple users, coordinating their work; the measurement task module is used to solve pose relationships of a scraper conveyor and a coal mining machine, linking poses of the mining and transportation equipment and support equipment to form a dynamic operational pose state of the working face. Data measured by AR is first processed by the measurement task module in the edge computer, where multi-user matching, data analysis, and preprocessing operations are performed, and then enters the measurement task module for separate solving of pose data of the mining and transportation equipment, achieving collaborative solving of the pose of the support equipment through bidirectional matching verification. Ultimately, solving results are fed back to the fields of view of the inspectors, enabling fast and efficient measurement of the mining and transportation equipment poses based on dual Hololens devices.

To achieve the above functions, a three-level coordinate system is established in the fully-mechanized mining face to achieve positioning in the entire fully-mechanized mining space. Three levels of coordinate systems are interrelated. With a first-level coordinate system as the reference, a third-level coordinate system implements coordinate transformation with a second-level coordinate system through matrix transformation, and the second-level coordinate system implements coordinate transformation with the first-level coordinate system through matrix transformation.

The first-level coordinate system is a coal seam coordinate system, with an initial mining position of a coal seam as an origin of the coal seam coordinate system, a layout direction of the working face as an X-axis, a horizontal advancement direction of the working face as a Y-axis, and a vertical direction as a Z-axis. This coordinate system serves as a positioning coordinate system for the entire space; every coordinate in the space is derived from the first-level coordinate system through matrix transformations, and the first-level coordinate system is used for positioning all coordinate systems in the working face.

The second-level coordinate system is a working face coordinate system formed by an overall configuration of three fully-mechanized mining machines, with a geometric center of a head cross-section of the scraper conveyor taken in a center-symmetric plane of a first head support in a head direction of the scraper conveyor as an origin, and coordinate axes being always parallel to the coal seam coordinate system. This coordinate system is used for expressing advancement information of the working face, describing the lateral and longitudinal operational conditions of the three fully-mechanized mining machines.

The third-level coordinate system includes local coordinate systems for each piece of equipment and an AR coordinate system, where the coal mining machine uses a geometric center of a body of the coal mining machine as a coordinate system origin, with a direction parallel to the body as an X-axis, a direction perpendicular to a front and back plane of the body as a Y-axis, and a direction perpendicular to an upper plane of the body as a Z-axis; the scraper conveyor is first divided into a plurality of units based on the number of middle troughs, and each middle trough unit uses a geometric center of an upper plane of the trough as a coordinate system origin, a direction parallel to a bottom plate and pointing towards the rear as an X-axis, a direction parallel to the bottom plate and pointing towards a coal wall as a Y-axis, and a direction perpendicular to a floor and pointing upwards as a Z-axis; the AR coordinate system is jointly formed by the two inspectors, with a geometric center of a Hololens device as a coordinate system origin, an inspection route along the layout direction of the working face as an X-axis, the horizontal advancement direction of the working face as a Y-axis, and the vertical direction as the Z-axis. This coordinate system is designed for active parts in the working face and the inspectors, used to finely describe the operation of each component and the inspection conditions of the inspectors.

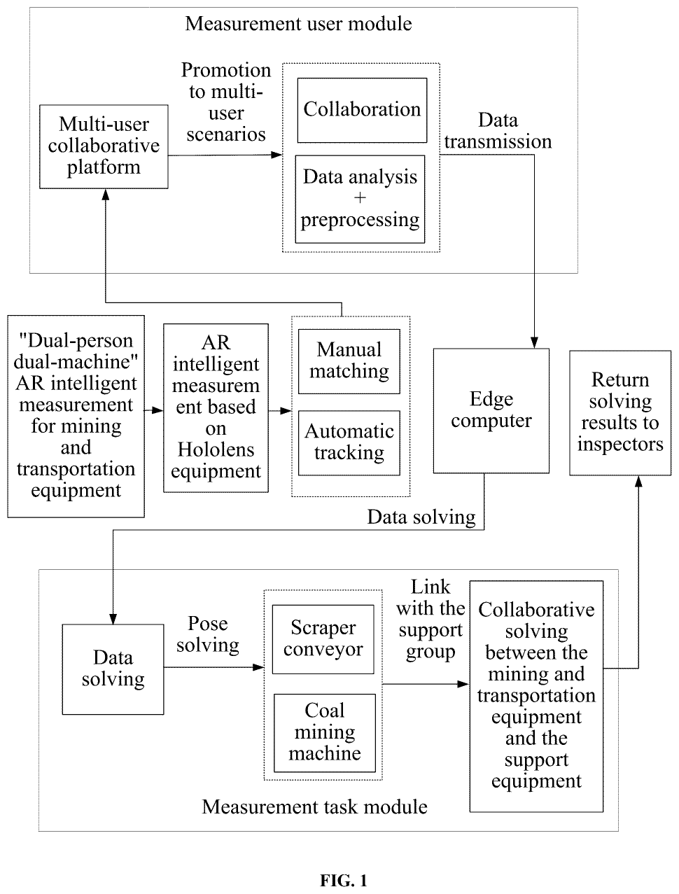

As shown in FIG. 1, the overall process of this embodiment includes an intelligent measurement module, a measurement user module, and a measurement task module.

The intelligent measurement module performs intelligent measurement based on

Hololens equipment, mainly including two parts: manual matching and automatic tracking. Automatic tracking can improve inspection efficiency and simplify inspection operations; manual matching can enhance inspection accuracy and ensure the reliability of measurement data.

Two experienced inspectors carry AR glasses and edge computers, conducting inspections from the front and rear ends. Through the AR glasses, the inspectors measure the pitch, roll, and yaw angles of the floating connection mechanisms, as well as distance relationships between different devices. Subsequently, the data is uploaded to the edge computers carried by the inspectors via the multi-user collaborative platform. After a preliminary assessment of the operational pose status of the mining and transportation equipment, data is fed back to the AR glasses worn by the two inspectors in the form of tasks. Ultimately, the two inspectors meet at the midpoint of the working face from two different starting points, and all information measured by the inspectors constitutes inspection results for the current inspection task. The inspection results are uploaded by the multi-user collaborative platform to a centralized control center to generate an inspection log, completing the intelligent and efficient inspection process.

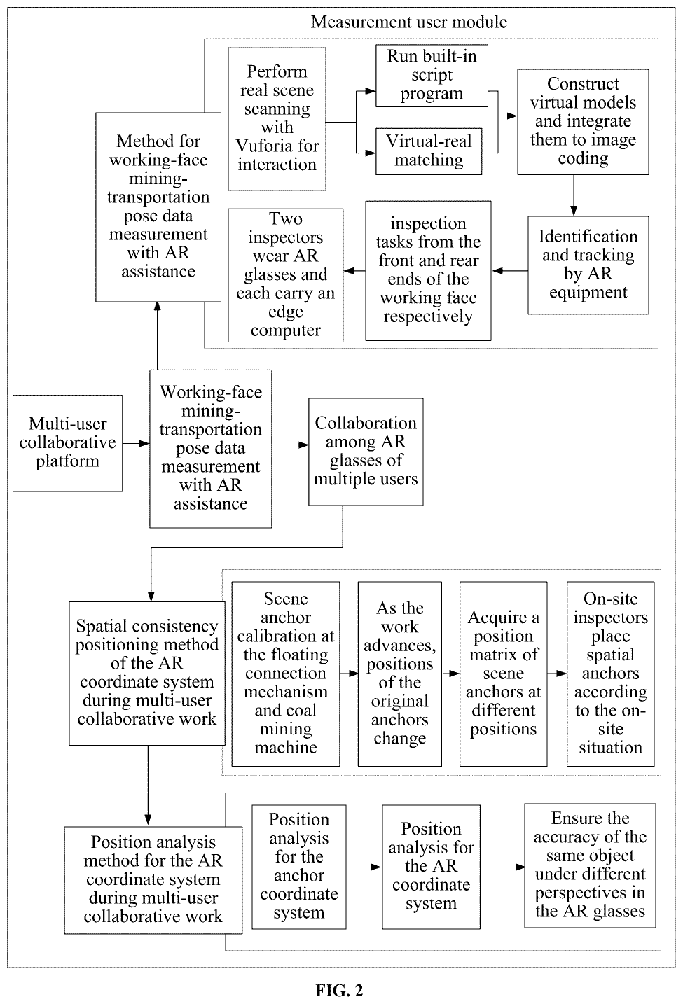

As shown in FIG. 2, the measurement user module is used for task collaboration among multiple users, coordinating their work. This module mainly includes a multi-user collaborative platform, responsible for real-time collaboration of measurement perspectives and measurement data among multiple users. All data is uniformly integrated and processed by the platform before being distributed to each user, ensuring consistency in measurement perspectives and measurement results displayed among different users, effectively improving the efficiency of multi-user collaborative operations.

The functionality of the multi-user collaborative platform is based on working-face mining-transportation pose data assisted by AR. The platform integrates multiple modules, including a multi-Hololens platform collaboration module and a network interaction module, and is equipped with built-in anchor calculation script and lightweight calculation script. The anchor calculation script is used to compute a position matrix of anchors, and an anchor group formed by multiple anchors can effectively determine the spatial consistency of multi-user coordinates. The lightweight calculation script is used to filter complex data; the filtered complex data is uploaded to a VR end via a local area network, where complex calculations are performed by the VR end, while simpler calculations are quickly performed by the inspection AR end. Together, these components form a complete multi-user collaborative system, enabling data upload and reception via the local area network and effectively avoiding data redundancy through the built-in pose calculation scripts, thus ensuring the accuracy of measurement data and significantly improving measurement efficiency.

An implementation process of an AR-assisted pose measurement method for the mining and transportation equipment is as follows: First, a Vuforia plugin is used for real scene scanning and modeling of the mining and transportation equipment, facilitating subsequent matching tasks during measurement. Then, scripts written in the Hololens platform run the program, and after matching the virtual model with the real equipment, the scripts automatically generate the measurement data. Similarly, the aforementioned pose measurement method can be further extended to dual inspection users.

A Vuforia tool is used to perform real scene scanning of fully-mechanized mining equipment at the working face, constructing a virtual model at the virtual end and integrating the virtual model into the inspection AR end. The AR devices identify and track the fully-mechanized mining equipment operating in a real working face, measuring pose information of corresponding parts in real time. During the operation in the fully-mechanized mining face, the scraper conveyor, due to the flexibility and spatial characteristics of its floating connection system, has difficulty ensuring straightness during the advancement process, leading to significant pose uncertainty. Therefore, a manual matching method is chosen for more precise positioning. In contrast, the operation of the coal mining machine is relatively stable, allowing for the addition of an AR automatic matching system to achieve automatic matching of feature blocks.

To ensure the collaboration between AR glasses of multiple users, an implementation process for the collaboration among the AR glasses of multiple users is as follows: First, groups of scene anchors for the scraper conveyor and the coal mining machine are constructed within the coal seam space to locate the position of the fully-mechanized equipment in the working face before operations begin. As operations progress, if the position of the mining and transportation equipment changes relative to the position calibrated by the scene anchors, the on-site inspectors will flexibly recalibrate the position based on the actual operating conditions. After each inspection shift, position data is saved as inspection data for that shift, gradually iterating with the increase in inspection shifts to reflect subtle changes in the working face. Once the anchors are positioned, a method for analyzing positions in the AR coordinate system during multi-user collaborative operations is as follows: First, position changes of the anchor coordinate system formed by the scene anchors and spatial anchors are analyzed to determine the consistency of the observation angles of the two inspectors. Based on this positioning, position analysis of the AR coordinate system of the two inspectors relative to the first-level coordinate system is performed, achieving accurate positioning of the same object from different perspectives.

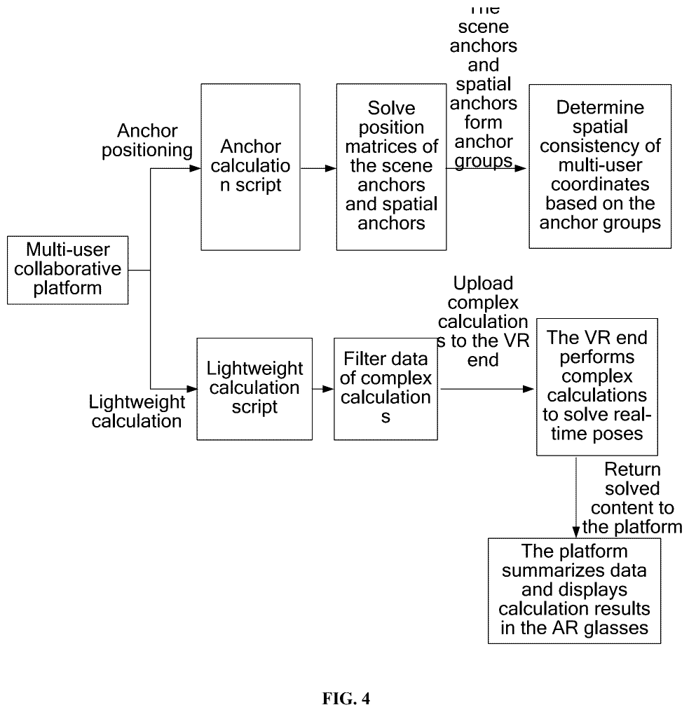

As shown in FIG. 4, the data processing flow of the multi-user collaborative platform can be divided into two aspects: anchor calculation and lightweight calculation.

For the issue of positioning anchors in multi-user coordinate consistency positioning, a method of jointly anchoring scene anchors and spatial anchors is adopted. The scene anchors are pre-calibrated during the virtual development process, where the scene anchors are based on the static positions of the three fully-mechanized mining machines, and are immutable. The scene anchor coordinate system formed by the scene anchors belongs to the second-level coordinate system of an entire coordinate system set. The spatial anchors are calibrated based on the dynamic conditions of the three fully-mechanized mining machines, flexibly calibrated by the inspectors during the inspection process according to the actual operating conditions of the working face. After each inspection shift, this data is saved as inspection data for that shift, gradually iterating with the increase in inspection shifts to reflect subtle changes in the working face. The spatial anchor coordinate system formed by the spatial anchors belongs to the third-level coordinate system of the entire coordinate system set.

The anchor calculation script is used to locate the anchors, defining a unified reference for multiple user perspectives by solving anchor groups formed by the scene anchors and spatial anchors, ensuring the spatial consistency of AR coordinates among multiple users in the same working face. The lightweight calculation script is used for data filtering, addressing the issue where the inspection AR end provides quick feedback but has weaker computing power, while the VR end has stronger computing power but relatively slower direct calculation feedback compared to the inspection AR end.

For the lightweight calculation issue, a method of filtering using the lightweight calculation script is adopted. Since the inspection AR end provides quick feedback but has weaker computing power, while the VR end has stronger computing power but relatively slower direct calculation feedback compared to the inspection AR end, the lightweight calculation script is inserted into the multi-user collaborative platform to avoid the drawbacks of traditional Hololens calculations that must go through a cloud VR platform. The lightweight calculation script is specifically designed for rapid data filtering; for example, when determining the translation distance and deflection angle of the floating connection mechanism of the scraper conveyor, or the cutting depth and angle of the coal mining machine (which are information that is relatively simple and time-sensitive), quick calculations are performed by the inspection AR end and immediately fed back to the inspectors. In contrast, more complex pose data, such as the overall swing angle of the scraper conveyor and the pose relationship between the coal mining machine and the hydraulic support, is quickly uploaded to the VR end via the local area network. After detailed calculations using the powerful computing capabilities of the VR end, the results are fed back to the inspectors through the local area network via the multi-user collaborative platform, maximizing the utilization of computing power from both the AR and VR ends while ensuring the timeliness of the inspection data acquisition.

For the pose calculation at the inspection AR end, a robotic arm model is used to determine pose conditions of the fully-mechanized mining equipment and inspectors by analyzing pose matrix change matrices of different objects at different times. For pose calculation of the fully-mechanized mining equipment, a base is first determined, and coordinate transformation matrices of each actuator point in joints of the fully-mechanized mining equipment are expressed as coordinates in relation to the base, thus reflecting the pose conditions of the entire fully-mechanized mining equipment; for pose calculation of the inspectors, by treating the inspectors as point masses in space and using the scene anchors as a reference, positions of the inspectors in space are determined, coordinates of the inspectors are expressed in terms of scene anchor coordinates, and then a corresponding pose matrix is converted into a spatial position matrix based on the first-level coordinate system, thus reflecting inspection paths of the inspectors through feedback of inspector poses.

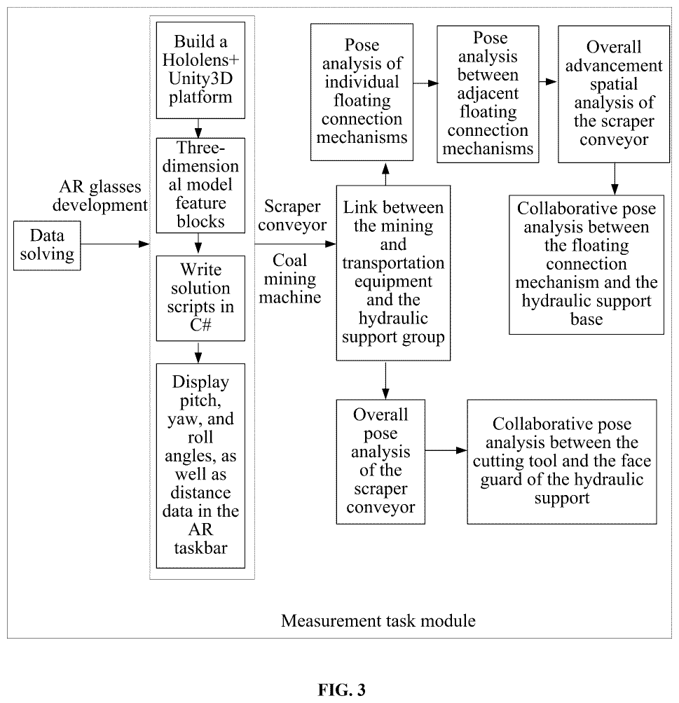

As shown in FIG. 3, the measurement task module is used to solve the pose relationships of the scraper conveyor and the coal mining machine, linking the poses of the mining and transportation equipment and the support equipment to form the dynamic operational pose state of the working face. This module primarily performs data solving tasks.

In the measurement task module, a data solving method is as follows: first, a preliminary development of the AR glasses worn by the inspectors is conducted, including three steps: building a Hololens+Unity3D platform, matching three-dimensional model feature blocks, and writing solution scripts in C#; ultimately, an AR taskbar displays pitch, yaw, and roll angles, as well as distance data of the scraper conveyor and the coal mining machine; after pose data of the mining and transportation equipment is obtained, the pose data is uploaded via the local area network, and collaborative solving for the mining and transportation equipment and the hydraulic support group is conducted in the cloud.

A method for collaborative solving of a pose relationship between the mining and transportation equipment and the hydraulic support group is as follows: for the scraper conveyor, the scraper conveyor is first divided into a plurality of units corresponding to hydraulic supports based on the number of floating connection mechanisms; poses of individual floating connection mechanisms and poses between adjacent floating connection mechanisms are analyzed to form an overall advancement spatial pose situation of the scraper conveyor; through a matching relationship between hydraulic cylinders of the floating connection mechanisms and bases of the hydraulic supports, a pose analysis task between the scraper conveyor and the hydraulic support group is completed; for the coal mining machine, an overall pose of the coal mining machine is first analyzed to form an overall operational spatial pose situation of the coal mining machine, and then, through a matching relationship between a cutting tool and a face guard of the hydraulic support, a pose analysis task between the coal mining machine and the hydraulic support group is completed.

To make the interaction between the mining and transportation equipment and the support equipment more precise, a bidirectional matching verification method is employed. The bidirectional matching verification is divided into two parts: a test set and a validation set. The test set is used for determining interaction results based on preset limit parameters by judging distance and angle parameters. If the distance is too close or the angles overlap, prompts for operations such as adjusting the face guard or moving the frame are issued. If the corresponding operations are not performed in the working face, the inspectors need to promptly contact the operators for adjustments. The validation set is used for conducting virtual simulations in virtual space, and with a relationship between the support equipment and the mining and transportation equipment as a basis for judgment, verifying whether an operational relationship between the support equipment and the mining and transportation equipment is normal based on whether there is interference in virtual space models.

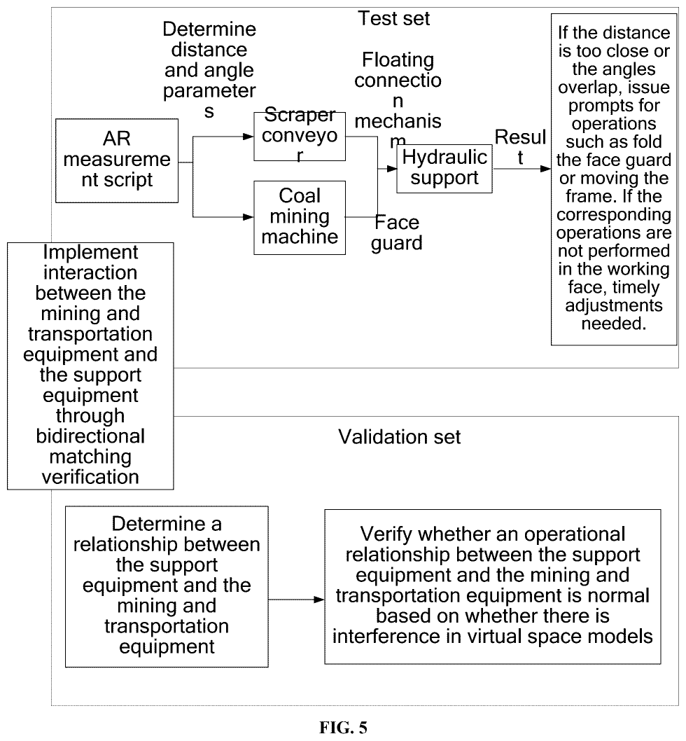

In a relatively specific implementation, as shown in FIG. 5, the interactive solving between the mining and transportation equipment and the support equipment employs a bidirectional matching verification method. The test set is used to solve the complex data uploaded by the multi-user platform. By using the AR measurement script, after the distance and angle parameters measured by the on-site inspectors are input, the pose information of the scraper conveyor and the coal mining machine can be calculated. Using the existing hydraulic support pose data in the test script, interactive solving for the floating connection mechanism of the scraper conveyor and the face guard of the coal mining machine is performed. Based on the solving results, prompts for operations such as adjusting the face guard or moving the frame are issued if the distance is too close or the angles overlap. If corresponding operations are not performed in a timely manner in the working face, the inspectors need to promptly contact the operators for adjustments. The validation set is used to verify the calculation results of the test set, further ensuring the accuracy of the solving results. The validation set continues to determine the relationship between the support equipment and the mining and transportation equipment in the virtual space of the VR end, checking the correctness of the solving results based on whether there is interference in the virtual space models. If the validation results of the validation set match the solving results of the test set, it indicates that the solving error is small; otherwise, the work log needs to be uploaded for further debugging by professionals.

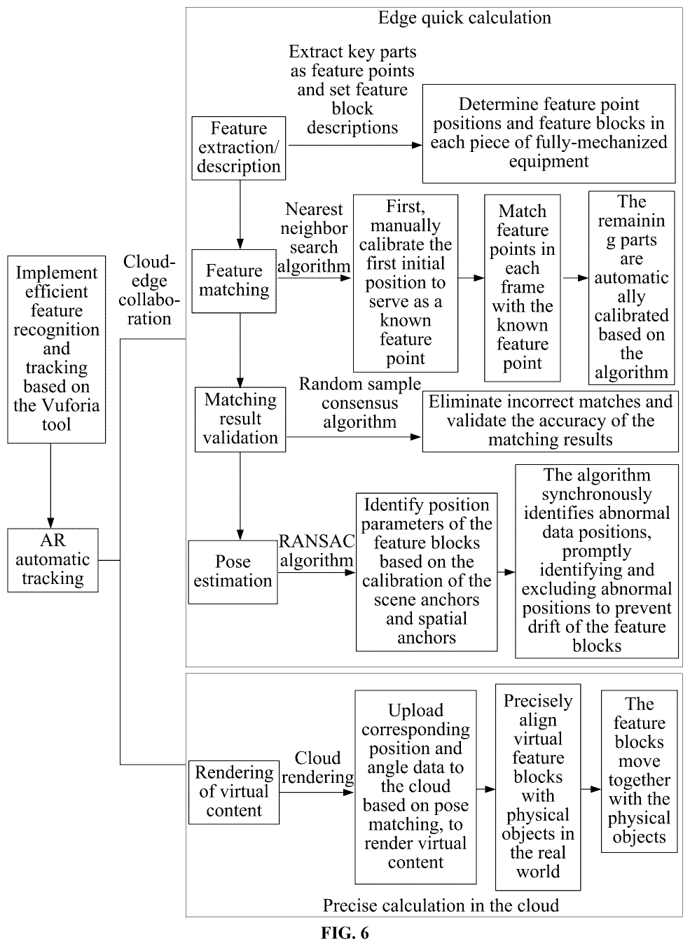

As shown in FIG. 6, the implementation of AR automatic tracking for the coal mining machine adopts a cloud-edge collaborative approach. By utilizing the efficient feature recognition and tracking capabilities of the Vuforia tool, feature matching is performed on a three-dimensional feature block model and the actual coal mining machine based on a built-in nearest neighbor search algorithm, a random sample consensus (RANSAC) algorithm, and a RANSAC algorithm script; accuracy of matching results is verified at the inspection AR end, and ultimately, through the multi-user collaborative platform, complex data is uploaded to the cloud for precise calculations and cloud rendering, allowing the feature blocks to move together with the coal mining machine. This eliminates some of the manual matching work that the inspectors would otherwise have to perform on-site, thus further enhancing the inspection efficiency.

This scheme is divided into two parts: rapid edge computing and precise cloud computing. The edge computing first extracts the geometric center of the coal mining machine, the axis of the cutting tool, and the connection part between the coal mining machine and the scraper conveyor as feature points. By constructing feature blocks for these feature points, a feature description of the coal mining machine is achieved. Next, feature matching is performed between the feature blocks of the coal mining machine and an actual coal mining machine. The inspectors manually calibrate the initial position before the coal mining machine begins operation, correlating the feature blocks with the position of the coal mining machine. After that, the built-in nearest neighbor search algorithm in the edge computer can match feature points in each frame with known feature points and continue to automatically calibrate as the coal mining machine moves. After feature matching is completed, the matching results are verified. The RANSAC algorithm is used to eliminate incorrect matches and validate the accuracy of the matching results. Once the correctness of the matching results is confirmed, the RANSAC algorithm is used to identify position parameters of the feature blocks and perform real-time pose corrections using the scene anchors and spatial anchors, promptly identifying and excluding abnormal data positions to prevent drift of the feature blocks.

The above four processes are quickly matched at the edge by the edge computer, while the rendering of virtual content is completed in the cloud. Based on the pose matching results, the corresponding position and angle data are uploaded for cloud rendering, allowing the virtual feature blocks to align precisely with the physical objects in the real world, enabling the feature blocks to move together with the physical objects.

Before the working face begins operations, two inspectors walk to their respective inspection positions at the front and rear ends. Upon reaching their designated locations, the two inspectors communicate via walkie-talkies to inform the control center that they are in position. At the same time, the two inspectors open their Hololens devices and connect to the multi-user collaborative platform at their respective inspection locations. After completing the above operations, the two inspectors are ready for immersive inspections, with virtual feature blocks of the fully-mechanized mining equipment at the front and rear ends appearing in their fields of view. The inspectors manually drag these feature blocks at the inspection AR end to match them with the corresponding fully-mechanized mining equipment. Once the taskbar of the AR glasses indicates “Matching complete, you can start the inspection work,” all preparations for the inspection task are complete. After confirmation from the control center, the operators start the machines, and the fully-mechanized mining operations begin. The two inspectors receive a new task on their taskbars: “Conduct inspection work,” and the inspection work starts simultaneously.

The inspector starting at the front end and the inspector starting at the rear end walk towards each other, measuring and checking data of the fully-mechanized mining equipment along the way. When the inspectors wear the AR glasses, they can observe simulation models of the fully-mechanized mining equipment. The AR glasses categorize the colors of the fully-mechanized mining equipment into red, yellow, and green. The red areas represent regions significantly affected by terrain factors and having unstable pose changes, making them key inspection targets. The green areas represent regions with relatively stable operations and pose change trends, serving as secondary inspection targets. The yellow areas indicate the inspection range for the inspectors, where the inspectors should conduct inspection tasks within the designated yellow range. Areas exceeding the yellow range are considered dangerous areas. If the inspectors go beyond this range, they will immediately receive a warning and will not be able to continue the inspection tasks. The inspectors can only resume the inspection tasks once they return to the designated inspection area.

While performing inspection tasks, each time the inspectors pass by the corresponding fully-mechanized mining equipment, they can touch the measurement button in the AR view to generate distance and angle information for the corresponding equipment. For areas with missing data or difficult measurements, the control center conducts unified command and issues real-time tasks to the taskbars of nearby inspectors. In addition to routine inspections, the inspectors will perform AR measurements from multiple angles at different times for these special areas, recording multiple sets of pose data to facilitate subsequent predictions and planning at the control center. Simpler pose data will be quickly calculated by the edge computers carried by the inspectors, such as the operational status of the floating connection mechanism of the scraper conveyor and the cutting conditions of the coal mining machine. The inspectors can also use their actual observations to assess the real terrain conditions in the working face and the operational status of the fully-mechanized mining equipment. For rugged or protruding positions not marked in the virtual end, the inspectors should promptly mark them and contact the operators for corrections based on the actual situation.

The AR inspection measurement end also includes emergency handling commands. When the inspectors encounter an emergency situation on-site, they can immediately click the emergency stop command on the inspection AR end. This command has the highest authority and can stop operations in the entire working face without approval from the operation end or control center. The scope of the emergency stop command includes: severe mechanical failures, such as motor overheating, mechanical component breakage, or excessive wear that may threaten the safety of on-site personnel or cause equipment damage; safety threats encountered by on-site personnel; unpredictable environmental factors such as gas increases or fires in the fully-mechanized mining area. The scope of the emergency stop command typically includes, but is not limited to, these three aspects. Inspectors must undergo specialized training before taking up their posts to respond correctly and promptly to emergencies.

Once the independent pose conditions of the floating connection mechanism and the coal mining machine are obtained, the relevant pose data is uploaded to the cloud via the multi-user collaborative platform by utilizing the powerful computing capabilities of the VR end. This allows for the calculation of pose relationships between the scraper conveyor, the coal mining machine, and the hydraulic supports, forming a complete pose relationship between the mining and transportation equipment and the support equipment.

After the two inspectors meet at the midpoint of the working face, the AR taskbar indicates “inspection complete.” The inspection tasks for the inspectors of this shift are essentially finished, and they can prepare to hand over to inspectors of the next shift. When the taskbar displays a “shift handover” task, the two inspectors continue to move along their inspection paths, where the inspector starting at the front end finishes the inspection at the rear end, and the inspector starting at the rear end finishes the inspection at the front end. While traveling from the meeting point to the inspection endpoints, the inspectors should also conduct inspections along the way, following the same inspection process. This part of the task is related to the shift handover. Meanwhile, the inspectors of the next shift enter the working face, preparing to stand by at their designated positions. After the inspection work of the previous shift is completed, the taskbar indicates “inspection task completed, shift handover.” The inspectors of the next shift put on their AR glasses, and continue with the inspection tasks.

Utilizing the multi-user collaborative platform for lightweight calculations and data interaction between AR and VR is key to maximizing AR measurement efficiency. The lightweight calculation script built into the inspection AR end is used to filter complex data, performing real-time calculations for simple data locally, while complex data is uploaded to the VR end for precise calculations, avoiding the drawbacks of traditional Hololens calculations that must go through a cloud VR platform. For example, the inspection AR end is used to determine the translation distance and deflection angle of the floating connection mechanism of the scraper conveyor, as well as the cutting depth and angle of the coal mining machine, which are relatively simple and time-sensitive information. The inspection AR end quickly calculates the poses of the floating connection mechanism, the coal mining machine, and the inspectors using the following formulas, which are then immediately fed back to the inspectors. The formulas are as follows:
where the pitch angle is defined as θ, the roll angle is defined as α, and the yaw angle is defined as γ. The pose matrix between adjacent floating connection mechanisms is represented by the following formula:

$${}^{i - 1} {T}_{i} = [ \begin{matrix}cos {θ}_{i} & - sin {θ}_{i} * cos {α}_{i} & sin {θ}_{i} * sin {α}_{i} & {a}_{i} * cos {θ}_{i} \\ sin {θ}_{i} & cos {θ}_{i} * cos {α}_{i} & - cos {θ}_{i} * sin {α}_{i} & {a}_{i} * sin {θ}_{i} \\ 0 & sin {α}_{i} & cos {α}_{i} & {d}_{i} \\ 0 & 0 & 0 & 1\end{matrix} ]$$

The pose matrix of the coal mining machine is represented by the following formula:

$${}^{M} {T}_{j} = [ \begin{matrix}cos α * cos γ & - cos α * cos γ & sin α & {d}_{x} \\ sin {θ}_{i} * sin α * sin γ + cos θ * sin γ & - sin θ * sin γ * sin α + cos θ * cos γ & - sin θ * cos α & {d}_{y} \\ - sin α * cos θ * cos γ + sin θ * sin γ & sin α * cos θ * sin γ + cos γ * sin α & cos θ * cos α & {d}_{z} \\ 0 & 0 & 0 & 1\end{matrix} ]$$

The pose of the inspector during the inspection is represented by the following formula:

$${A}^{} P = {}^{B} P + {}^{A} {P}_{{B}_{0}}$$

where A represents the coal seam coordinate system, B represents the motion coordinate system of the inspector on the moving rigid body, and B0 represents the origin of the motion coordinate system.

The overall swing angle of the scraper conveyor and the complex pose relationship between the coal mining machine and the hydraulic supports are quickly uploaded to the VR end via the local area network. At the VR end, a virtual model is constructed based on Unity3D, establishing a real-time data transmission framework between the scraper conveyor and Unity3D through Transmission Control Protocol/Internet Protocol (TCP/IP), and creating a data storage method primarily based on Extensible Markup Language (XML) and Structured Query Language (SQL) Server databases. This allows for flexible retrieval of data for further planning and solving the complex pose relationships between the mining and transportation equipment and the support equipment. After detailed calculations using the powerful computing capabilities of the VR end, the results are fed back to the inspection users through the local area network via the multi-user collaborative platform, maximizing the utilization of computing power from both the AR and VR ends while ensuring the timeliness of the inspection data acquisition.

During AR measurements, there may also be issues with inconsistent inspection rhythms, meaning that the speed of manual matching by inspectors is slower than the operational speed of the fully-mechanized mining equipment, leading to disconnection in inspections. The solution to this problem is to combine manual matching with automatic matching. For the scraper conveyor with more complex operation, manual matching is chosen for precise matching, while for the coal mining machine with relatively stable operation, automatic matching is employed to improve inspection efficiency.

What is claimed is:

1. A dual-person dual-machine measurement method for mining and transportation equipment, comprising an intelligent measurement module, a measurement user module, and a measurement task module,
wherein the intelligent measurement module comprises two inspectors conducting inspections in opposite directions and Augmented Reality (AR) glasses carried by the inspectors, and is configured to collect working-face mining-transportation pose data based on Hololens equipment by using manual matching and automatic tracking methods;
the measurement user module is built into edge computers carried by the inspectors and comprises a multi-user collaborative platform, wherein the multi-user collaborative platform measures the working-face mining-transportation pose data under AR assistance and performs data processing operations, and the multi-user collaborative platform enables real-time collaboration of measurement perspectives and data among multiple users; and
the measurement task module is responsible for clarifying measurement tasks for the multi-user collaborative platform and for solving data feedback from the measurement tasks, wherein driven by tasks, a virtual solving platform is built for an actual working state of mining and transportation equipment; pose information of a scraper conveyor and a coal mining machine is solved in real time based on measurement data fed back by users, and is used for collaborative solving of pose information of a hydraulic support group in the multi-user collaborative platform, thereby integrating the pose information of the mining and transportation equipment with the pose information of the support equipment, and solving results are simultaneously fed back to an inspection AR end in the form of tasks.

2. The method according to claim 1, wherein the multi-user collaborative platform, based on the working-face mining-transportation pose data under AR assistance, integrates a multi-Hololens platform collaboration module and a network interaction module, uses a Vuforia tool to perform real scene scanning of fully-mechanized mining equipment at a working face, constructs a virtual model at a virtual end, and integrates the virtual model into the inspection AR end, wherein AR devices identify and track the fully-mechanized mining equipment operating in a real working face, measuring pose information of corresponding parts in real time.

3. The method according to claim 1, comprising establishing a three-level coordinate system in a fully-mechanized mining face;
wherein a first-level coordinate system is a coal seam coordinate system that takes an initial mining position of a coal seam as an origin of the coal seam coordinate system, a layout direction of the working face as an X-axis, a horizontal advancement direction of the working face as a Y-axis, and a vertical direction as a Z-axis, and is used for locating all coordinate systems in the working face;
a second-level coordinate system is a working face coordinate system formed by an overall configuration of three fully-mechanized mining machines, with a geometric center of a head cross-section of the scraper conveyor taken in a center-symmetric plane of a first head support in a head direction of the scraper conveyor as an origin, and coordinate axes being always parallel to the coal seam coordinate system; and
a third-level coordinate system comprises local coordinate systems for each piece of equipment and an AR coordinate system, wherein the coal mining machine uses a geometric center of a body of the coal mining machine as a coordinate system origin, with a direction parallel to the body as an X-axis, a direction perpendicular to a front and back plane of the body as a Y-axis, and a direction perpendicular to an upper plane of the body as a Z-axis; the scraper conveyor is first divided into a plurality of units based on the number of middle troughs, and each middle trough unit uses a geometric center of an upper plane of the trough as a coordinate system origin, a direction parallel to a bottom plate and pointing towards the rear as an X-axis, a direction parallel to the bottom plate and pointing towards a coal wall as a Y-axis, and a direction perpendicular to a floor and pointing upwards as a Z-axis; the AR coordinate system is jointly formed by the two inspectors, with a geometric center of a Hololens device as a coordinate system origin, an inspection route along the layout direction of the working face as an X-axis, the horizontal advancement direction of the working face as a Y-axis, and the vertical direction as a Z-axis.

4. The method according to claim 3, wherein a data processing flow of the multi-user collaborative platform comprises anchor calculation of scene anchors and spatial anchors;
the scene anchors are pre-calibrated during a virtual development process, based on static positions of the three fully-mechanized mining machines, and a scene anchor coordinate system formed by the scene anchors belongs to the second-level coordinate system of an entire coordinate system set; and
the spatial anchors are calibrated based on dynamic conditions of the three fully-mechanized mining machines, flexibly calibrated by the inspectors during an inspection process according to actual operating conditions of the working face, and after an inspection shift, saved as inspection data for the inspection shift, wherein the inspection data gradually iterates as the number of inspection shifts increases; a spatial anchor coordinate system formed by the spatial anchors belongs to the third-level coordinate system of the entire coordinate system set.

5. The method according to claim 1, wherein the data processing flow of the multi-user collaborative platform comprises lightweight calculation to filter complex data; filtered complex data is uploaded to a virtual reality (VR) end via a local area network, and complex calculations are performed by the VR end, while simpler calculations are quickly performed by the inspection AR end.

6. The method according to claim 5, wherein for pose calculation at the inspection AR end, a robotic arm model is used to determine pose conditions of the fully-mechanized mining equipment and the inspectors by analyzing pose matrix change matrices of different objects at different times; for pose calculation of the fully-mechanized mining equipment, a base is first determined, and coordinate transformation matrices of each actuator point in joints of the fully-mechanized mining equipment are expressed in relation to the base, thus reflecting the pose conditions of the entire fully-mechanized mining equipment; for pose calculation of the inspectors, by treating the inspectors as point masses in space and using the scene anchors as a reference, positions of the inspectors in space are determined, coordinates of the inspectors are expressed in terms of scene anchor coordinates, and then a corresponding pose matrix is converted into a spatial position matrix based on the first-level coordinate system, thus reflecting inspection paths of the inspectors through feedback of inspector poses.

7. The method according to claim 1, wherein in the measurement task module, a data solving method is as follows: first, a preliminary development of the AR glasses worn by the inspectors is conducted, comprising three steps: building a Hololens+Unity3D platform, matching three-dimensional model feature blocks, and writing solution scripts in C#; ultimately, an AR taskbar displays pitch, yaw, and roll angles, as well as distance data of the scraper conveyor and the coal mining machine; after pose data of the mining and transportation equipment is obtained, the pose data is uploaded via the local area network, and collaborative solving for the mining and transportation equipment and the hydraulic support group is conducted in cloud.

8. The method according to claim 7, wherein a method for collaborative solving of a pose relationship between the mining and transportation equipment and the hydraulic support group is as follows: for the scraper conveyor, the scraper conveyor is first divided into a plurality of units corresponding to hydraulic supports based on the number of floating connection mechanisms; poses of individual floating connection mechanisms and poses between adjacent floating connection mechanisms are analyzed to form an overall advancement spatial pose situation of the scraper conveyor; through a matching relationship between hydraulic cylinders of the floating connection mechanisms and bases of the hydraulic supports, a pose analysis task between the scraper conveyor and the hydraulic support group is completed; for the coal mining machine, an overall pose of the coal mining machine is first analyzed to form an overall operational spatial pose situation of the coal mining machine, and then, through a matching relationship between a cutting tool and a face guard of the hydraulic support, a pose analysis task between the coal mining machine and the hydraulic support group is completed.

9. The method according to claim 1, wherein a bidirectional matching verification method is used to achieve interaction between the mining and transportation equipment and the hydraulic support group; bidirectional matching verification is divided into two parts: a test set and a validation set; the test set is used for determining interaction results based on preset limit parameters by judging distance and angle parameters; the validation set is used for conducting virtual simulations in virtual space, and with a relationship between the support equipment and the mining and transportation equipment as a basis for judgment, verifying whether an operational relationship between the support equipment and the mining and transportation equipment is normal based on whether there is interference in virtual space models.

10. The method according to claim 9, wherein for the coal mining machine that operates more stably, a cloud-edge collaborative strategy is employed; by utilizing efficient feature recognition and tracking capabilities of the Vuforia tool, feature matching is performed on a three-dimensional feature block model and the coal mining machine based on a built-in nearest neighbor search algorithm, a random sample consensus (RANSAC) algorithm, and a RANSAC algorithm script; accuracy of matching results is verified at the inspection AR end, and ultimately, through the multi-user collaborative platform, complex data is uploaded to the cloud for precise calculations and cloud rendering, allowing the feature blocks to move together with the coal mining machine.

11. The method according to claim 2, comprising establishing a three-level coordinate system in a fully-mechanized mining face;
wherein a first-level coordinate system is a coal seam coordinate system that takes an initial mining position of a coal seam as an origin of the coal seam coordinate system, a layout direction of the working face as an X-axis, a horizontal advancement direction of the working face as a Y-axis, and a vertical direction as a Z-axis, and is used for locating all coordinate systems in the working face;
a second-level coordinate system is a working face coordinate system formed by an overall configuration of three fully-mechanized mining machines, with a geometric center of a head cross-section of the scraper conveyor taken in a center-symmetric plane of a first head support in a head direction of the scraper conveyor as an origin, and coordinate axes being always parallel to the coal seam coordinate system; and
a third-level coordinate system comprises local coordinate systems for each piece of equipment and an AR coordinate system, wherein the coal mining machine uses a geometric center of a body of the coal mining machine as a coordinate system origin, with a direction parallel to the body as an X-axis, a direction perpendicular to a front and back plane of the body as a Y-axis, and a direction perpendicular to an upper plane of the body as a Z-axis; the scraper conveyor is first divided into a plurality of units based on the number of middle troughs, and each middle trough unit uses a geometric center of an upper plane of the trough as a coordinate system origin, a direction parallel to a bottom plate and pointing towards the rear as an X-axis, a direction parallel to the bottom plate and pointing towards a coal wall as a Y-axis, and a direction perpendicular to a floor and pointing upwards as a Z-axis; the AR coordinate system is jointly formed by the two inspectors, with a geometric center of a Hololens device as a coordinate system origin, an inspection route along the layout direction of the working face as an X-axis, the horizontal advancement direction of the working face as a Y-axis, and the vertical direction as a Z-axis.

12. The method according to claim 4, wherein the data processing flow of the multi-user collaborative platform comprises lightweight calculation to filter complex data; filtered complex data is uploaded to a virtual reality (VR) end via a local area network, and complex calculations are performed by the VR end, while simpler calculations are quickly performed by the inspection AR end.

13. The method according to claim 6, wherein in the measurement task module, a data solving method is as follows: first, a preliminary development of the AR glasses worn by the inspectors is conducted, comprising three steps: building a Hololens+Unity3D platform, matching three-dimensional model feature blocks, and writing solution scripts in C#; ultimately, an AR taskbar displays pitch, yaw, and roll angles, as well as distance data of the scraper conveyor and the coal mining machine; after pose data of the mining and transportation equipment is obtained, the pose data is uploaded via the local area network, and collaborative solving for the mining and transportation equipment and the hydraulic support group is conducted in cloud.

14. The method according to claim 8, wherein a bidirectional matching verification method is used to achieve interaction between the mining and transportation equipment and the hydraulic support group; bidirectional matching verification is divided into two parts: a test set and a validation set; the test set is used for determining interaction results based on preset limit parameters by judging distance and angle parameters; the validation set is used for conducting virtual simulations in virtual space, and with a relationship between the support equipment and the mining and transportation equipment as a basis for judgment, verifying whether an operational relationship between the support equipment and the mining and transportation equipment is normal based on whether there is interference in virtual space models.
